(19) United States
(12) Patent Application Publication
(10) Pub. No.: US 2016/0296962 A1
(43) Pub. Date: Oct. 13, 2016

(54) A DEVICE FOR DISPENSING A COMPOSITION AND METHODS OF DISPENSING A COMPOSITION

(71) Applicant: 3M INNOVATIVE PROPERTIES COMPANY, Saint Paul, MN (US)

(72) Inventors: Steven J. Maxa, Lakeville, MN (US); Bruce R. Broyles, Oakdale, MN (US)

(21) Appl. No.: 15/037,952

(22) PCT Filed: Nov. 24, 2014
(86) PCT No.: PCT/US2014/067012

§ 371 Date: May 19, 2016

Related U.S. Application Data
(60) Provisional application No. 61/908,223, filed on Nov. 25, 2013.

(51) Int. Cl. B05C 17/005; A61C 5/06

(52) U.S. Cl. CPC B05C 17/00593; B05C 17/00513; B05C 17/00579; B05C 17/00516; A61C 5/062

(57) ABSTRACT

Devices and related methods are provided for dispensing compositions having a tip (72) including an inner tapered funnel portion (74); a hollow barrel (84) including an outer tapered surface portion (86), an inner surface, an open front end, and an open back end opposite the front end; and a piston (16), where the outer tapered surface portion of the barrel aligns and releasably engages with the inner tapered funnel portion of the tip, and where the piston is in sliding engagement with the barrel. Applications include, but are not limited to, dispensing dental materials such as composites, adhesives, etchants, glass ionomers, cements, and sealants.

### BACKGROUND

Positive displacement dispensers, including syringes and capsules, are used in diverse industrial and commercial applications. Such devices find uses in medicine, laboratory processes, cooking, adhesives, inks, and others. Particular applications of devices are found in, for example, dispensing and measuring quantities of medications, adhesives, lubricants, resins, or even food products such as cake frosting.

One common type of positive displacement dispenser is a syringe. Syringes use a simple piston pump consisting of a plunger that fits tightly in a cylindrical tube or barrel. A composition is provided in a chamber within the barrel, and the plunger can be pulled and pushed along the barrel, allowing the syringe to take in and/or expel the composition through an orifice located at an open end of the barrel. Optionally, the open end is fitted with a hypodermic needle, nozzle, or tubing to help direct the flow of the composition into and out of the barrel.

In many of applications, it is desirable for air pockets or air bubbles to be expelled from the chamber of the syringe to prevent air from becoming entrained in the dispensed composition. In some cases, this can be accomplished by merely inverting the syringe to consolidate air bubbles at the front end of the chamber and discharging them through the orifice prior to use. However, this is an inconvenient extra step and not always practical or possible when dealing with viscous pastes or liquids.

Another approach to this problem is to use vented syringes. Vented syringes generally employ a plunger with an exit channel that is impervious to the composition but readily allows the passage of air. As the plunger is advanced into the barrel of the syringe, the channel redirects undesirable air pockets or bubbles out of the chamber to eliminate them from the dispensed composition. Examples of vented syringe concepts have been disclosed in issued U.S. Pat. No. 4,572,210 (McKinnon), U.S. Pat. No. 4,660,569 (Etherington), U.S. Pat. No. 5,865,803 (Major), U.S. Pat. No. 6,916,308 (Dixon), and U.S. Pat. No. 7,503,905 (Jessop et al.), U.S. Patent Publication No. 2002/0076671 (Markus et al.), published British Patent Application No. GB 1 475 430 (Fischbach), International Application No. WO 2009/029974 (Kiehne), and U.S. Patent Publication No. 2012/0181300 (Maxa et al.)

Although the commercial success of available dispensers has been impressive, it is desirable to further improve the performance of such dispensers, particularly relative to reducing air pockets or air bubbles.

### SUMMARY

One aspect of the present invention provides a device for dispensing a composition. In one embodiment the device comprises: a tip comprising an inner tapered funnel portion; a hollow barrel including an outer tapered surface portion, an inner surface, an open front end, and an open back end opposite the front end; and a piston, wherein the outer tapered surface portion of the barrel aligns and releasably engages with the inner tapered funnel portion of the tip, and wherein the piston is in sliding engagement with the barrel. In another embodiment, the device for dispensing a composition, comprises a tip comprising an inner tapered funnel portion and a dome portion adjacent the inner tapered funnel portion, wherein the inner tapered funnel portion of the tip includes a conical surface; a hollow barrel including an outer tapered surface portion including a conical surface and a plurality of venting grooves, an inner surface, an open front end, and an open back end opposite the front end; and a piston; and a cannula attached to the tip at the dome portion; wherein the conical surface of the outer tapered surface portion of the barrel aligns and releasably engages with the conical surface of the inner tapered funnel portion of the tip.

Another aspect of the present invention provides a method of dispensing a composition from a device. In one embodiment, the method comprises: providing a device for dispensing a composition, comprising: a tip comprising an inner tapered funnel portion; a hollow barrel including an outer tapered surface portion, an inner surface, an open front end, and an open back end opposite the front end; and a piston, wherein the outer tapered surface portion of the barrel aligns and releasably engages with the inner tapered funnel portion of the tip, and wherein the piston is in sliding engagement with the barrel; filling the device with a dental composition; and dispensing the dental composition by moving the piston relative to the hollow barrel, wherein the dental composition is dispensed when the piston is moved relative to the hollow barrel and the dental composition is not dispensed when the piston stops relative to the hollow barrel.

Certain terms are used in the description and the claims that, while for the most part are well known, may require some explanation. It should be understood that, when referring to “tortuous” this means along a path that includes a plurality of twists, bends, or curves. The term “helical” or “helix” means along a generally spiral-shaped path. The term “coincident” means travelling in a synchronized fashion. The term “align” or “aligns” means to be in line with.

The above summary of the present invention is not intended to describe each disclosed embodiment or every implementation of the present invention. The Figures and the detail description, which follow, more particularly exemplify illustrative embodiments.

### BRIEF DESCRIPTION OF THE DRAWINGS

The present invention will be further explained with reference to the appended Figures, wherein like structure is referred to by like numerals throughout the several views, and wherein:

FIG. 1A is a perspective view of a prior art dispenser with the tip assembly disengaged from the syringe and plunger assembly;

FIG. 1B is a perspective view of the prior art dispenser of FIG. 1A assembled.

FIG. 2A is a cross sectional view of a portion of a prior art dispenser;

FIG. 2B is a cross sectional view of a portion of the prior art dispenser of FIG. 1.

FIG. 3 is an x-ray of a dental composition in the prior art dispenser of FIGS. 1A, 1B and 2B;

FIG. 4 is a photograph of the prior art dispenser of FIGS. 1A, 1B, and 2B, showing “run on” composition at the tip;

FIG. 5 is a cross sectional view of one embodiment of a portion of the dispenser of the present invention;

FIG. 6 is a cross sectional view of one embodiment of the dispenser of the present invention including the portion shown in FIG. 5 and the barrel of FIG. 10;

FIGS. 7A-7C are photographs of a clear embodiment dispenser of FIGS. 5 and 6 in use;

FIG. 8 is a photograph of the dispenser of FIGS. 7A-7C showing no “run on” after use;

FIG. 9 is an x-ray of the dispenser of FIG. 7C;

FIG. 10 illustrates a perspective view of embodiment of a hollow barrel of the present invention;

FIG. 11A is a magnified view of the hollow barrel including one embodiment of a plurality of venting grooves;

FIG. 11B is a magnified view of the hollow barrel including another embodiment of a plurality of venting grooves;

FIG. 11C is a magnified view of the hollow barrel including yet another embodiment of a plurality of venting grooves;

FIG. 11D is a further magnified view of the hollow barrel including a further embodiment of venting grooves;

FIG. 11E is an inset showing in greater detail the grooves located along the outer surface of the hollow barrel;

FIG. 12 is a cross sectional view of the hollow barrel of FIG. 11C with the tip assembly of FIG. 5; and

FIG. 13 is a cross sectional view of another embodiment of a portion of the dispenser of the present invention.

### DETAILED DESCRIPTION

There are a variety of positive displacement dispensers known in the art, including syringes and capsules, which are used in diverse industrial and commercial applications. Such dispensers dispense a variety of compositions. Applications include, but are not limited to, dispensing dental materials such as composites, adhesives, etchants, glass ionomers, cements, and sealants.

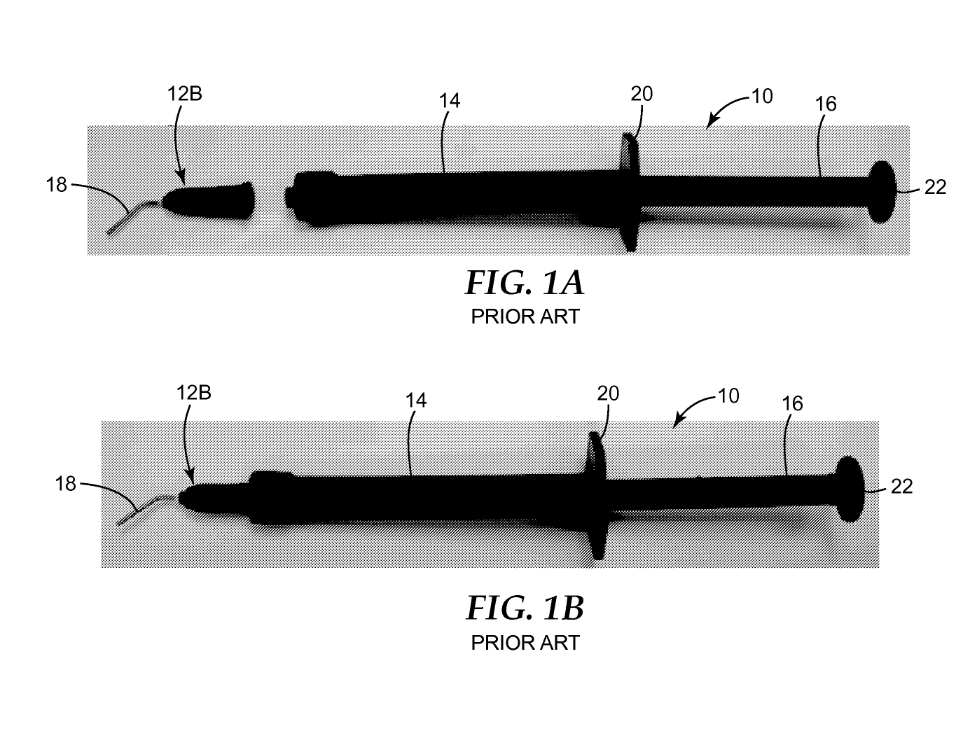

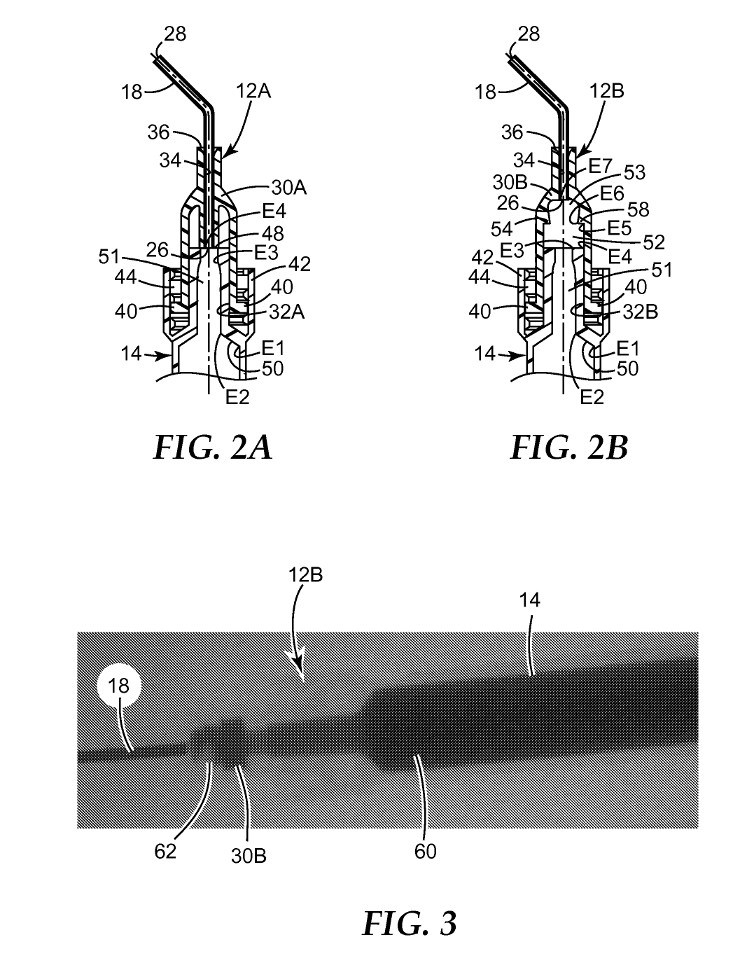

One common type of positive displacement dispenser is a syringe, as discussed in the Background above. FIGS. 1A-1B and 2A-2B illustrate two types of prior art syringes. FIGS. 1A, 1B, and 2B illustrate a first prior art syringe available from 3M Company in St. Paul, Minn. The syringe 10 has a tip assembly 12B that is releasably engaged with a hollow barrel 14, as illustrated in FIG. 1A. This configuration is to allow the tip to be easily replaced and provide a single use tip, where a new tip may be used for each new patient. The tip assembly 12B has a cannula 18 attached at one end of the tip assembly 12B. The tip assembly 12B releasably engages or attaches to the barrel 14 at the end opposite the cannula 18 of tip assembly 12B. Tip assembly 12B is commercially available as part number 70-2010-5038-5 from 3M Company. Hollow barrel 14 is commercially available as part number 78-8131-1621-3 from 3M Company. The syringe 10 also includes a piston or plunger 16 that can be pushed along the barrel, allowing the syringe 10 to expel a composition contained therein through an orifice located at the open end of the barrel 14. To assist configuring the syringe 12 to fit a person's hand and to assist the piston 16 to slideably engage with the barrel 14, the barrel 14 includes a finger flange 20 and the piston includes a thumb flange 22.

FIG. 2A illustrates the configuration of a tip assembly 12A of a second prior art dispenser. This dispenser is commercially available from Transcodent GmbH & Co. based in Kiel, Germany. The tip assembly 12A includes a tip 30A and a cannula 18. The tip 30A includes an outer surface 34 and an inner surface 32A. The inner surface 32A is configured for receiving the cannula 18. The inner surface 32A is generally cylindrical in shape, forming a first opening 36 at one end of the tip 30A and a second opening at the opposite end of the generally cylindrical shape. The cannula 18 also has a first opening 26 and a second opening 28 opposite the first opening 26. The outer cylindrical portion of the cannula 18 attaches the cannula 18 to the cylindrical inner surface of the tip 30A via pressure fit. The first opening 26 of the cannula 18 terminates adjacent an opening in the tip 30A into a minor chamber 51 of the hollow barrel 14 located at the second end 48 of the barrel 14.

The tip assembly 12A mounts to the barrel 14 through use a “lure lock” style connection, which is well known by those skilled in the art. With this connection, an ear 40 on the outer surface 34 of the tip 30A releasably locks into helical threads 44 of a lure lock connector 42. One disadvantage of the lure lock style connection includes that it can be difficult to disinfect the connection between each use with patients.

FIG. 2B illustrates the configuration of a tip assembly 12B of a prior art dispenser illustrated in FIGS. 1A-1B. Tip assembly 12B is commercially available as part number 70-2010-5038-5 from 3M Company. Tip assembly 12B includes a tip 30B and a cannula 18 that is similar to the cannula 18 in FIG. 2A, except that it is shorter and does not telescope as deep into the tip 30B. The tip assembly 12B also attaches to the barrel 14 with tip 30B using the same lure lock style connection as FIG. 2A. However, the tip 12B includes an additional chamber configuration in comparison to tip 12A. Tip 12B includes a major chamber 52 and a minor chamber 53. There is a lip located at the end of the barrel 14 adjacent the major chamber 52, and there is a reverse taper or undercut 54, which forms an edge 58 between the major chamber 52 and the minor chamber 53.

In FIG. 2B, when the piston 16 (not shown) is pushed into the hollow barrel 14, the dental composition contained in the barrel flows from a major chamber 50 into the minor chamber 51 of the barrel 14. Then, the dental composition flows into the major chamber 52 and minor chamber 53 of the tip assembly 12. Lastly, the dental composition flows into the first opening 26 and out the second opening 28 of the cannula 18. The composition encounters at least seven different edges or corners as it flows in this direction, indicated as E1, E2, E3, E4, E5, E6, and E7. (Note that the tip assembly 12A includes a reduced number of edges or corners E1-E4.) These edges or corners may introduce the possibility or likelihood of increasing turbulence, and therefore may help increase the likelihood or the possibility of forming air bubbles in the composition. Some edges or corners may contribute more turbulence, where other edges or corners may contribute less turbulence. Regardless, as discussed above, these edges or corners introduce the possibility or likelihood of increasing turbulence, and thus forming air bubbles in the composition, as discussed in greater detail relative to FIG. 3.

FIG. 3 is an x-ray of a dental composition in the prior art dispenser of FIGS. 1A-B and 2B, which are convenient for illustrating the problem of air bubbles formed in the dental composition. The white portion of the x-ray illustrates a dental composition 60 within the prior art device 10. In this x-ray, the dental composition 60 was FILTEK brand Supreme Ultra Flowable Restorative commercially available from 3M Company based in St. Paul, Minn. The x-ray outlines in black the hollow barrel 14 and the tip assembly 12B of the prior art dispenser.

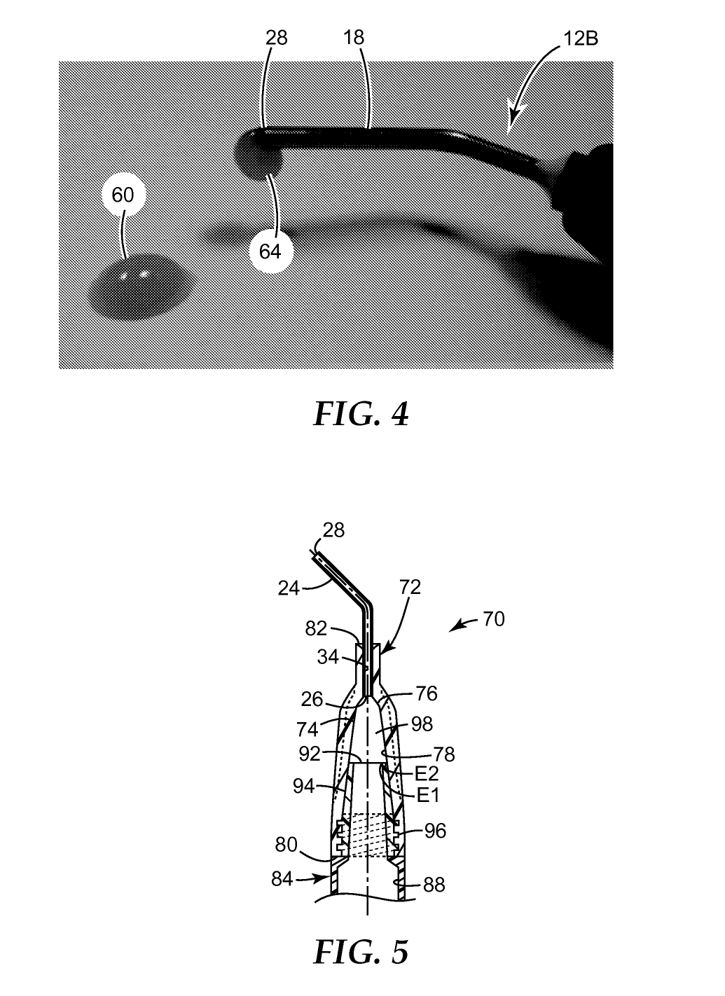

The dispenser will hold a volume of dental composition 60 to be used on multiple patients. The dispensing tip 12B is designed for each patient to have a new tip. After a tip is used on a patient, it is disposed of and replaced with a new tip 12B for the next patient. The replaceable tip assembly 12B illustrated will commonly develop air bubbles somewhere in the space between the major chamber 52 and the first opening 26 of the cannula 18. As discussed above, the various edges E within the tip assembly 12B may contribute to the formation of air bubbles. An air bubble 62 in the dental composition 60 is illustrated in the tip 30a between the undercut 54 and the cannula 18. However, air bubbles can form anywhere within the tip assembly 12B. The air bubble 62 will compress under pressure as the piston pushes the dental composition 60 through the cannula 18. Then, when the user stops extruding the dental composition out of the second end 28 of the cannula 18 by stopping the advancement of the piston and thus decreasing pressure on the composition 60, the air bubble 62 will relax and slowly expand back to its original size. This, in turn, causes the dental composition to continue exiting from the second end 28 of the cannula 18, thereby causing residual discharge of the composition 60, also known as “run-on” or “drool” from the tip assembly 12B. Such run-on 64 is illustrated in FIG. 4. FIG. 4 illustrates the dental composition 60 on the surface dispensed as intended by the user, such as a dentist, when the piston is pushed. The run-on 64 dripping from the second end 28 of the cannula 18 is what occurred after the dentist stopped advancing the piston in the device 10. This run-on is wasteful and unintended. Moreover, if the dental composition was applied directly into the patient's mouth using the prior art device 10, the run-on would then be applied unintentionally inside the patient's mouth, which is bothersome to both the dentist and the patient.

In addition, it is possible that the air bubble 62 may randomly split into smaller bubbles and then go through the cannula 18 mixed within the dental composition 60. In this case, it is possible that when the dental composition is applied to the restoration, the air bubbles will be entrained within the composition. This may cause the dentist the need to rework the restoration before curing the dental composition, which is inefficient and bothersome to both the dentist and the patient.

Lastly, there may be a concern in the cleaning and disinfecting of a multiuse syringe after each use. The female portion of the “lure lock” style connector 42 to mount the tip assembly 12A, 12B to the barrel 14 can be difficult to disinfect due to its various helical threads 44 (illustrated in FIGS. 2A-2B). Often, it may be difficult to get disinfectant along all the surfaces of the threads 44.

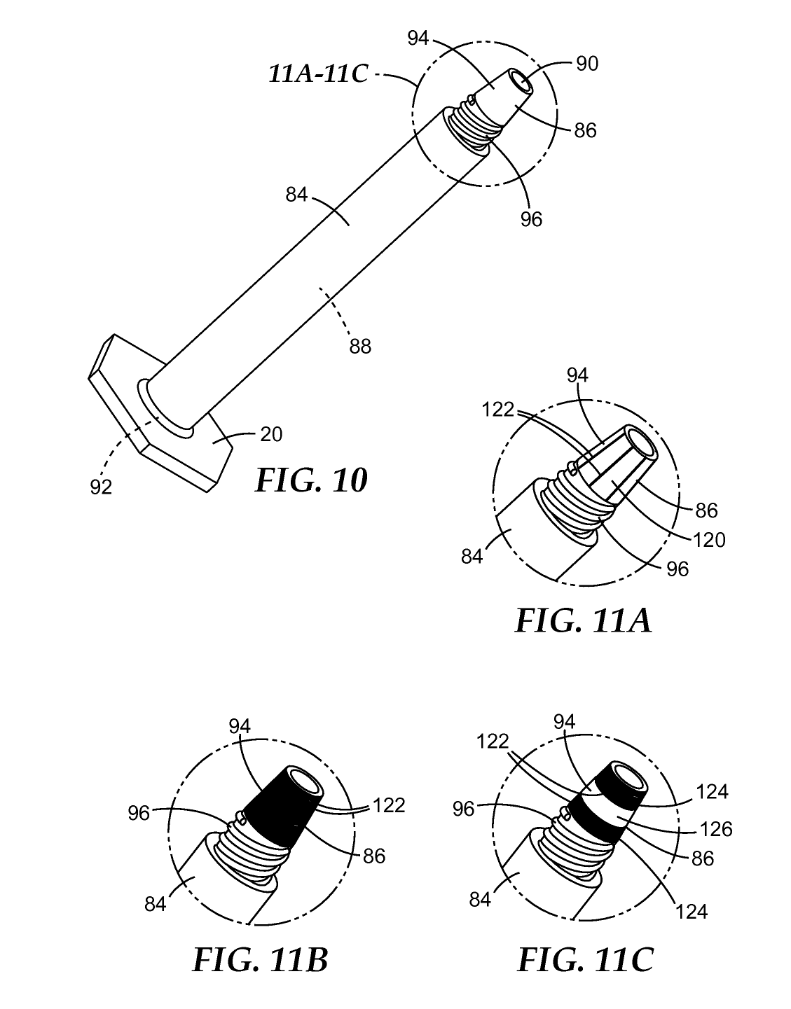

The device for dispensing a composition of the present invention helps overcome these difficulties described above and provides other benefits to both the user and patient. In one aspect, the device of the present invention provides specially designed parts of the device, which align and releasably engage with each other. For example, as explained in more detail below in reference to FIGS. 5-9 and FIG. 13, an outer tapered surface portion of the barrel aligns and releasably engages with an inner tapered funnel portion of the tip. This tapered funnel shape design assists in pushing air out through the tip ahead of the dental composition, as it is being dispensed from the device of the present invention. In another aspect, the device of the present invention also provides specially designed venting grooves on the outer tapered portion of the barrel. For example, as explained in more detail below in reference to FIGS. 10-12, the venting grooves on the barrel are shaped and sized to allow air to vent out to the atmosphere between the tip and the barrel, but are designed to prevent any dental composition to leak.

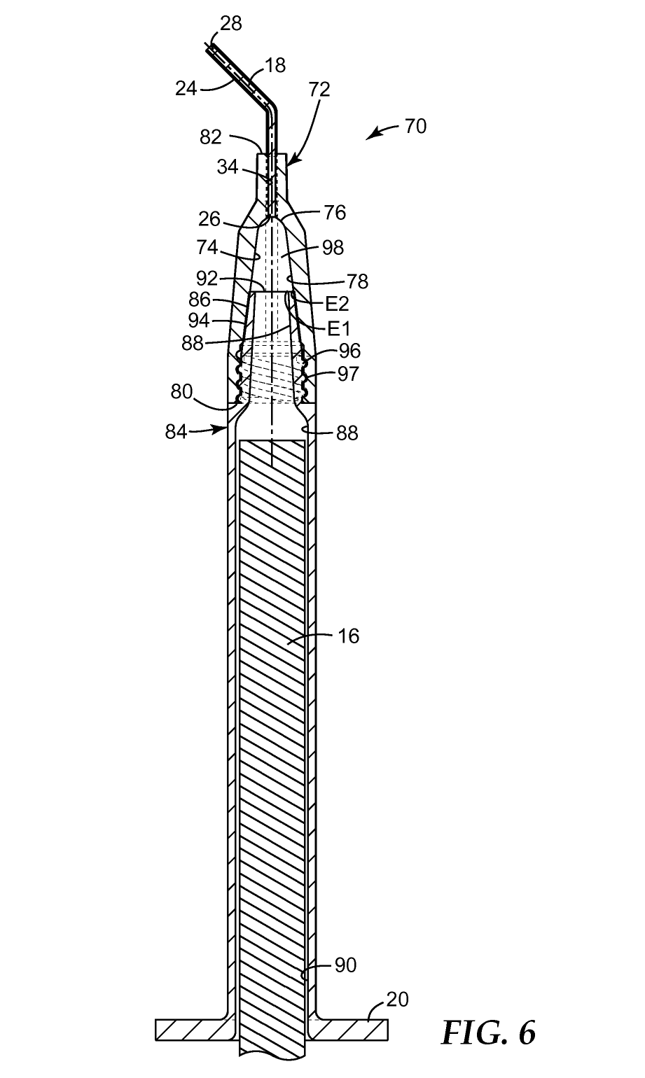

FIGS. 5 and 6 illustrate one embodiment of the device 70 for dispensing a composition of the present invention. The dental composition 60 resides in the cavity 98, and at least partially fills the hollow barrel 84. The composition may be a paste, gel, viscous liquid, or any other deformable material capable of being displaced and extruded out of the dispensing device 70. In exemplary embodiments, the composition 60 is a dental material such as a composite, adhesive, etchant, glass ionomer, cement, or sealant. The device 70 of the present invention is particularly suited for dispensing highly viscous materials, such as viscous dental pastes.

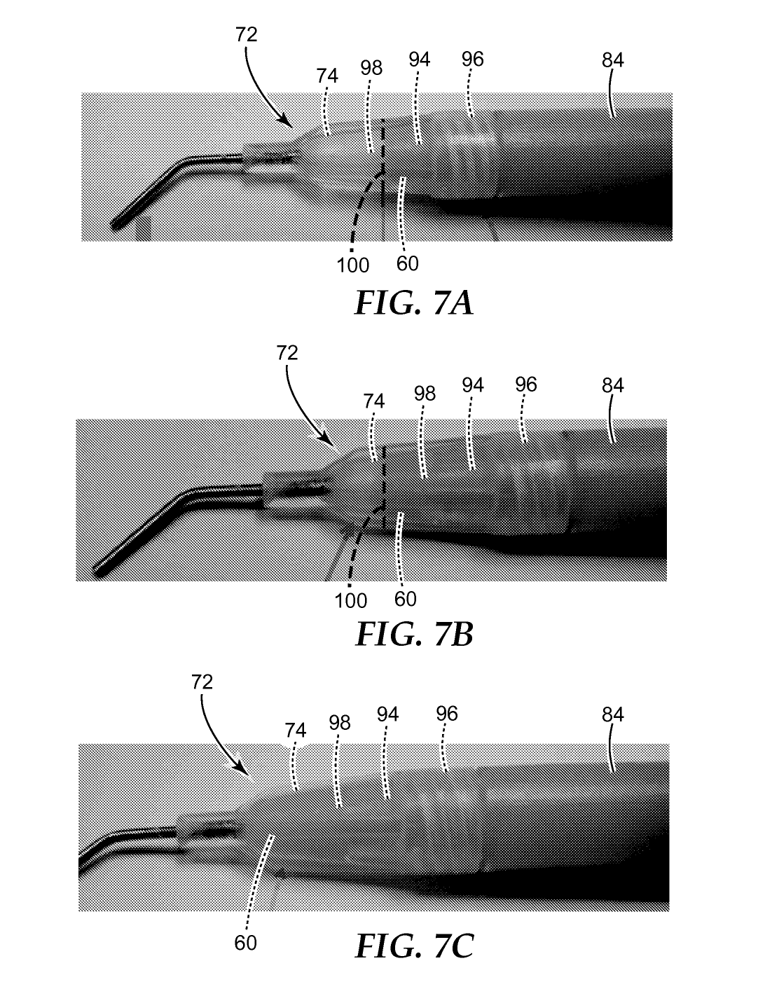

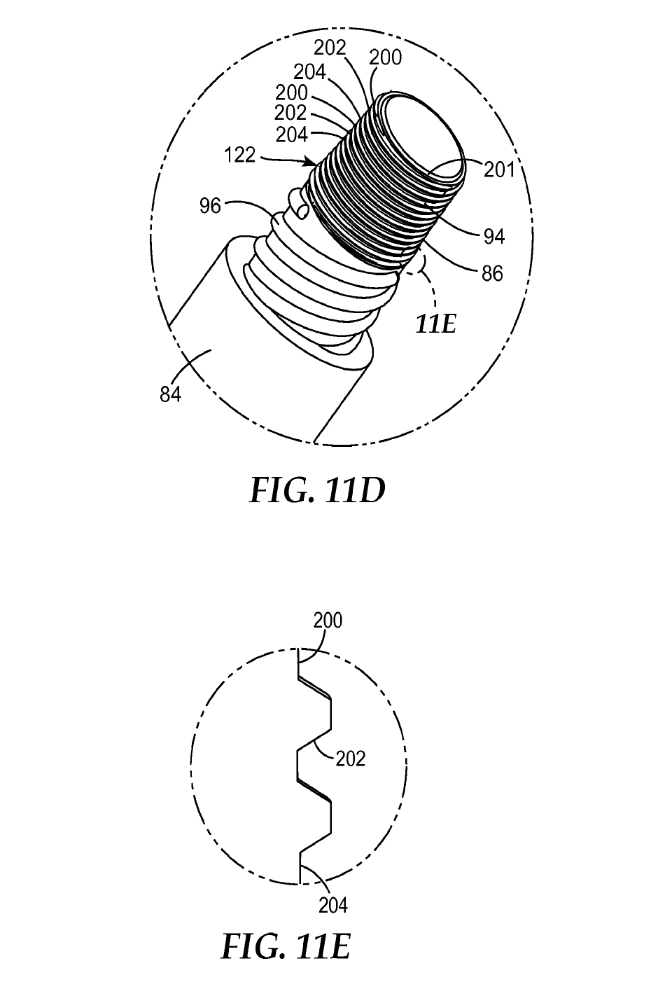

Device 70 includes a tip assembly 72, a hollow barrel 84, and a piston 16. The tip assembly 72 includes a tapered funnel portion 74. In the illustrated embodiment, the tapered funnel portion includes a conical surface 78 and a dome shaped surface 76 forming cavity 98. However, other embodiments of a tapered funnel portion may be envisioned by those skilled in the art. The smooth tapered funnel surface does not have any hard edges in contact with the composition as it flow through the cavity 98 and into the cannula 18, as illustrated in FIGS. 7 and 9, which helps minimize air bubbles from forming in the composition. In the illustrated embodiment, the hollow barrel 84 has an outer tapered surface portion 86. The cannula 18 may be made of plastic or metal. Various embodiments of this outer tapered surface portion 86 are illustrated in FIGS. 6, 10, 11A-11E, 12 and 13. FIGS. 6 and 10 illustrate a smooth outer tapered surface portion 86, whereas FIGS. 11A-E and 12 illustrate grooved regions with a plurality of venting grooves. Regardless, the inner tapered funnel portion 74 of the tip 70 aligns and releasably engages with the outer tapered surface portion 86 of the barrel 14, or vice versa, the outer tapered surface portion 86 of the barrel 14 aligns and releasably engages with the inner tapered funnel portion 74 of the tip 70. The piston 16 is in sliding engagement with the hollow barrel 84. A composition is provided in a chamber within the hollow barrel 84, and the piston can be pushed along the barrel 84 by a user, allowing the device 70 expel the composition through the second opening 28 of the cannula 18 with worrying about run-on of the composition at the tip, as discussed above. In other words, the composition is dispensed from the dispenser 70 only when the piston 16 is moved relative to the hollow barrel 84.

In contrast to the tip assemblies 12A and 12B illustrated in FIGS. 2A and 2B, the tip assembly of the invention includes only two edges, E1 and E2, which the composition contacts while being dispensed. This design helps reduce the possibility or likelihood of increasing turbulence in the composition and thus reduces the likelihood of the formation of air bubbles within the tip assembly 72, which in turn dramatically reduces residual discharge of the composition, also known as “run-on” or “drool” discussed above, thereby providing superior control in dispensing the composition. If the outer tapered surface portion 86 of the barrel 84 is smooth, then it creates both an air tight fit and a fluid tight fit with the smooth tapered funnel portion 74. However, if the outer tapered surface portion 86 has one of the alternative surfaces illustrated in FIGS. 11A-E, then it creates a fluid tight fit but not an air tight fit with the smooth tapered funnel portion 74, which provides certain advantages, as discussed in greater detail below.

The tip assembly 72 is meant to be replaceable with a new tip 72 for each patient, and thus releasably engages with a threaded portion including threads on the surface of the barrel 84 and grooves 97 on the inner surface of the tip 72. This configuration is much easier to clean and disinfect compared to the lure lock connection between the tip and barrel illustrated in FIGS. 2A and 2B. After each use, the tip assembly 72 is unscrewed from the barrel 84 and thrown away. Then, the outer tapered surface portion 86 and the threads 96 of the barrel are easily wiped clean with a cloth having disinfectant sprayed on by rubbing the cloth along the portion 86 and threads 96 as the barrel 84 is twisted relative to the cloth. Afterword, a new tip assembly 72 is screwed onto the barrel 84 and the device 70 is ready for the next patient.

FIGS. 7A-7B illustrate a relatively clear prototype of the device of the present invention made by sterolithography with a dental composition therein, as the piston is moved relative to the barrel 84. In FIG. 7A, the dental composition 60 is in just beginning to flow from the barrel 84 and into the cavity 98 within the tip assembly 72. The flow front 100 of the dental composition is shown in FIGS. 7A and 7B. In FIG. 7B, the piston has been advanced relative to the barrel, and the air is pushed toward the cannula 18 along the tapered funnel portion 74 of the tip 72 to vent out the cannula 18 and not get trapped within the tip 72. In FIG. 7C, the piston has been further advanced relative to the barrel, and the composition 60 has now entered the cannula 18. As illustrated through the clear prototype, there are no air bubbles trapped in the tip, and all the air was properly vented out of the device 70 through the cannula 18.

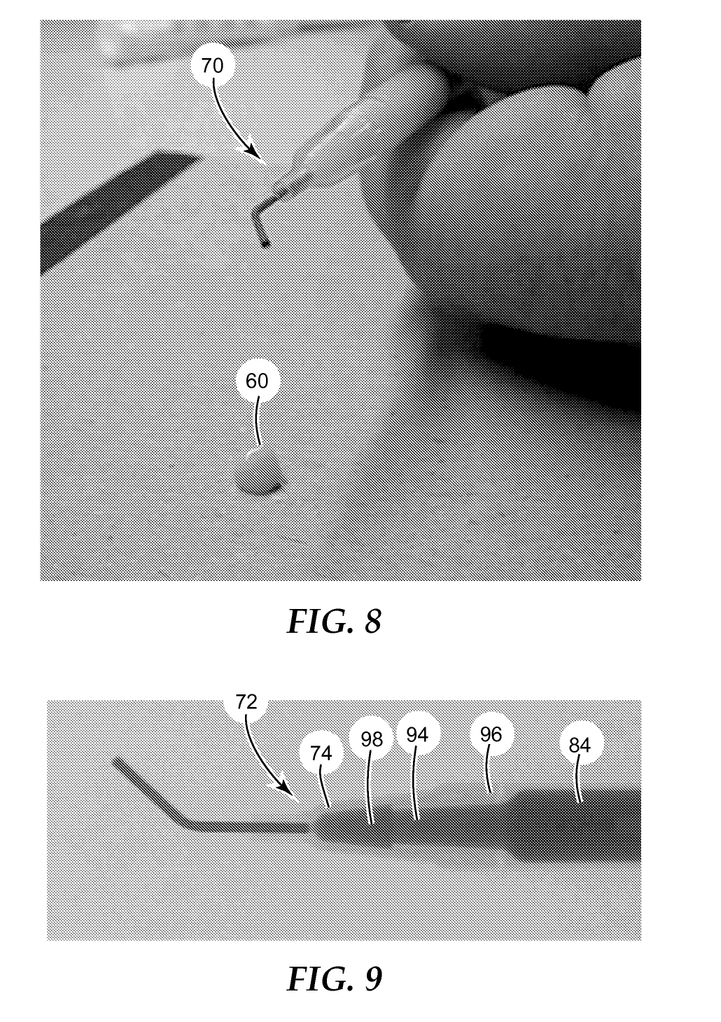

FIG. 8 illustrates the device 70 of FIGS. 7A-7C approximately one minute after the piston has stopped relative to the hollow barrel. As illustrated, there is no run on or drool of the composition out of the nozzle. (The examples below also illustrate these phenomena.) This is in sharp contrast to the prior art device illustrated in FIG. 4.

FIG. 9 is an x-ray of the device 70 of the present invention as illustrated after FIGS. 7C and FIG. 8. As confirmed by the x-ray, there are no air bubbles in the cavity 98 within the device 70. This is in sharp contrast to the x-ray of the prior art device shown in FIG. 3.

FIGS. 7A-7C, 8 and 9 conveniently illustrate the various benefits of the device 70 for dispensing a composition of the present invention. First, the tapered funnel portion 74, including the conical surface 78 and dome shaped surface 76, in combination with the outer tapered surface portion 86 of the barrel 84, including the conical surface 94, provide a cavity where essentially no air bubbles form within the composition in the tip. Although not being held to any one theory, the inventors believe air bubbles are eliminated in this configuration because the geometry created by the combination of the outer tapered surface 86 of the barrel and the tapered funnel portion 74 of the tip provides a smooth passage way for the composition 60 to flow from the barrel 14, into the tip assembly 72, and into the cannula 18. By eliminating any hard, sharp edges or corners, the changes of introducing turbulence into the composition is significantly reduced. Moreover, this design allows air to move through the tip and out of the cannula ahead of the flow front 100 of the dental composition 60 being dispensed. By eliminating the formation of air bubbles, run-on of the dental composition composition 60 from the device 70 after the piston is stopped relative to the barrel does not occur. By eliminating run-on of the composition, the composition is not unnecessarily wasted after the user has stopped pressing down on the piston. Also, by eliminating run-on of the composition, the user, in this case a dentist, doesn't have to fear that extra dental composition will be dispensed in unintended areas of the patient's mouth. Instead, the dentist can have confidence that the composition will be dispensed only where he intends upon the advancement of the piston into the barrel. This provides improved ease of use, a smoother application of the composition, and better visibility and reliability for the use of the device. In addition, by essentially eliminating air bubbles from forming within the device air bubbles do not become entrained in the dental composition 60 going through the cannula 18. This substantially reduces the likelihood of having small air bubbles in the dental composition when it is applied to the restoration thereby requiring the dentist to rework the restoration before curing the dental composition. Any procedure using the “bubble free” device 70 of the present invention will take less time and provide the dentist with more accurate application of a dental composition. Lastly, the outer tapered surface 86 of the barrel 84 is also easier to clean and disinfect compared to prior art devices, particularly those with a lure lock connection.

FIG. 10 illustrates one embodiment of the hollow barrel 84 of the present invention. The hollow barrel 84 includes an outer tapered surface 86, an inner surface 88 opposite the outer surface 86, an open front end 90 and an open back end 92 opposite the open front end. The barrel 84 optionally may also include a finger flange 20, and a threaded portion 96 in the form of threads. FIG. 10 illustrates the conical surface 94 of the outer tapered surface 86 of the barrel 84 as a smooth surface. This helps forms a tight seal between the barrel and tip as shown in FIGS. 5 and 6.

FIGS. 11A-11E illustrate different embodiments of the outer tapered surface portion 86 of the barrel 84.

FIGS. 11A-E illustrate a variety of different embodiments of the outer surface portion 86 having a plurality of grooves. These groves are useful for venting air, while not allowing the composition to leak due to the relative size of the grooves. These various embodiments are designed to assist in reducing or eliminating the formation of the bubbles in the dental composition, as the dental compositions is pushed through the hollow barrel by the piston. These embodiments either allow air to escape out of the cavity 98 formed between the tip 72 and the barrel 84 in the direction of the second open end 92 of the barrel, or it traps the air to prevent it from entering the dental composition all together, or some combination of both. Although FIGS. 11A-E illustrate at least four different embodiments, this should not be considered limiting, as other designs may known by those skilled in the art.

FIG. 11A illustrates one embodiment where the outer tapered surface includes trapezoidal portions 120 between adjacent venting grooves 122.

FIG. 11B illustrates another embodiment where the plurality of venting grooves 122 are parallel and coincident with each other and in a helical pattern on the outer tapered surface 86.

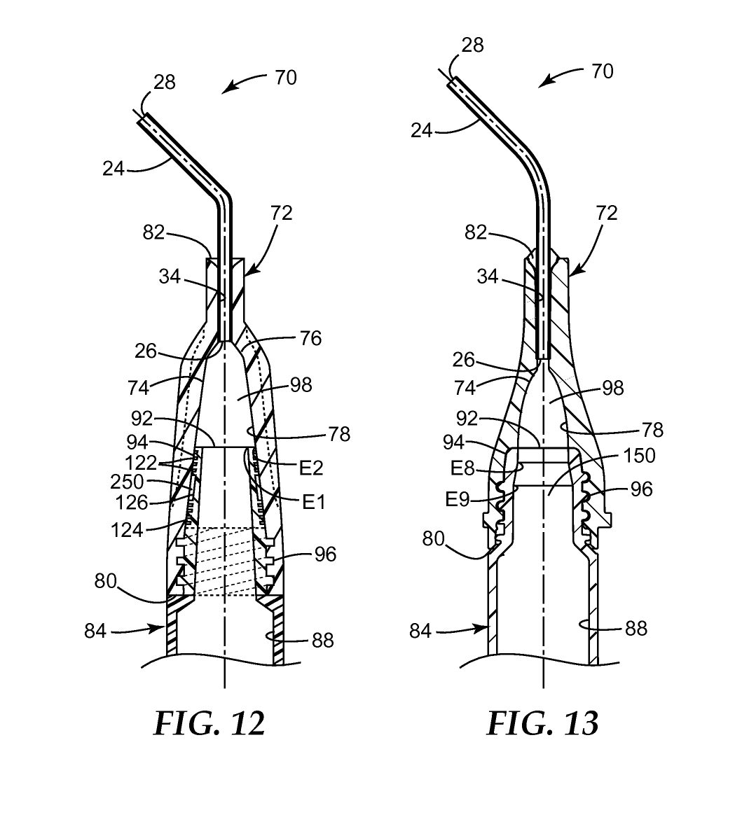

FIG. 11C illustrates yet another embodiment where the plurality of grooves are parallel and coincident with each other and extend across two or more grooved regions 124, the grooved regions 124 being spaced apart from each other and a smooth surface 126 extending between the grooved regions 124. This particular embodiment is shown in combination with the tip assembly 72 in FIG. 12 and discussed in more detail below.

FIG. 11D illustrates in detail the plurality of venting grooves 122 which are parallel and coincident with each other and form helix around the outer tapered surface portion 86 of the barrel 84. In this depiction, the outer surface 86 includes three tortuous grooves 200, 202, 204 extending around the outer tapered surface 86. The grooves 200, 202, 204 are parallel and coincident with each other and form a helix around the outer surface 86 about the longitudinal axis of the barrel 84. Using a helical configuration is advantageous, since it is easy to manufacture and allows the grooves 200, 202, 204 to traverse significant distances even when the surface area of the surface 86 is limited. In some embodiments, the helical grooves 200,202,204 have a pitch ranging from 4 to 40 turns per centimeter (approximately 10 to 100 turns per inch).

FIG. 11E illustrates a magnified cross sectional view of the plurality of venting grooves 122 shown in FIG. 11D. As shown in the inset, the grooves 200, 202, 204 have a generally trapezoidal cross-section. Semi-circular grooves, V-shaped grooves, rectangular grooves, or grooves of any other shape may also be used. In one particular useful embodiment, the plurality of venting grooves 122 have a cross-sectional area ranging from 0.006 square millimeters to 0.06 square millimeters. On particularly suitable embodiment of grooves is taught in U.S. Patent Publication 2012/0181300 A1, “Dispensing Device with Pressure Release,” (Maxa et al.), which is hereby incorporated by reference.

Although FIGS. 11B-11E illustrate the venting grooves on the outer surface of the barrel, it is contemplated that the venting grooves could alternatively be designed on the inner tapered surface funnel surface 74 of the tip 72. As another alternative, the tapered surfaces could be roughened or provided with a pattern of raised portions to provide other embodiments of venting grooves not illustrated.

FIG. 12 illustrates the barrel 84 of FIG. 11C in combination with the tip assembly 72 of FIG. 5. This combination is useful for creating a narrow cavity 250, which helps trap air between the different regions 124 of grooves. As the piston 16 (not shown) is moved relative to the hollow barrel 84, or in sliding engagement with the barrel, the dental composition is dispensed out of the tip assembly 72 through the cannula 24. Meanwhile, any air that was previously trapped in the cavity 98 formed between the tip assembly 72 and the barrel 84, when a new tip assembly was put on the device, will escape to the atmosphere through the plurality of venting grooves 122 and threads 96, or become trapped temporarily between the small, narrow cavity 250 formed between the barrel and the tip.

Lastly, FIG. 13 illustrates yet another embodiment of the device 70 for dispensing a composition of the present invention. The device 70 illustrated in FIG. 13 is very similar to the embodiment of the device 70 illustrated in FIG. 5, with a few exceptions. In the configuration illustrated in FIG. 13, edges E1 and E2 have been eliminated to provide even a smoother transition between inner surface 88 of the hollow barrel 84 and the conical surface 78 of the tip assembly 72. There are slight edges E8 and E9 within cavity 150. The cavity 98 of the tip assembly 72 is slightly shorter in overall length, and the cavity 150 of the hollow barrel is shorter in overall length. And, the dome portion 76 has been minimized or eliminated.

The operation of the present invention will be further described with regard to the following detailed examples. These examples are offered to further illustrate the various specific and preferred embodiments and techniques. It should be understood, however, that many variations and modifications may be made while remaining within the scope of the present invention.

### EXAMPLES

### Example 1

### Preparation of SLA Models

A hollow barrel syringe body and tip were designed using CAD software (NX Unigraphics v.7.5, available from Siemens PLM, Munich, Del.). The designs for the hollow barrel and tip are shown in FIG. 6. The CAD designs were then used to prepare stereolithographic (SLA) models using a stereolithographic printer (3D Systems Viper available from 3D Systems, Rock Hill, S.C.) and Somos XC 11122 resin (available from DSM, Elgin, Ill.) along with a UV cure. The cured SLA models were clear and mimicked injection molded plastics. A 20 gauge stainless steel metal cannula identical to the cannula used on FILTEK brand Supreme Ultra Flowable Restorative (available from 3M Company, St Paul, Minn.) was affixed to the prepared SLA syringe tip by simply pressing the cannula into the small opening at the front of the tip. The interior of the hollow barrel was designed to the same specification as the interior of hollow barrel used in FILTEK brand Supreme Ultra Flowable Restorative 2 gram syringe (available from 3M Company, St Paul Minn.). However, the outer surface of the hollow barrel was designed to engage with the tip such that there was a smooth transition between the outer surface of the hollow barrel and the disposable syringe tip when they were properly engaged, as illustrated in FIGS. 5 and 6. This smooth transition between syringe body and syringe tip combined with the tapering interior design of the disposable tip eliminated air entrapment or bubble formation in the tip when in use.

### Example 2

### Extrusion of a Flowable Composite Dental Material

The SLA syringe tip with 20 gauge stainless steel metal cannula was affixed to the SLA hollow barrel syringe body (from Example 1) and then partially filled with FILTEK brand Supreme Ultra Flowable Restorative paste (available from 3M Company, St. Paul, Minn.). A plunger from a FILTEK brand Supreme Ultra Flowable Restorative 2 gram syringe (available from 3M Company, St Paul Minn.) was inserted into the open end of the hollow barrel syringe body. The plunger was pressed into the restorative paste by hand. As the plunger was pressed into the paste the paste advanced into the tip and toward the metal cannula keeping the air ahead of the flow front and venting out the metal cannula. No air bubbles were seen forming or being retained in the restorative paste within the syringe tip, as illustrated in FIGS. 7A-C. When the pressure was removed from the plunger, the flow of restorative paste stopped and did not continue to run on or drool from the cannula opening, as shown in FIG. 8. As shown in FIG. 9, an X-ray (using an NSI Cabinet Digital X-ray Model X-View IW, available from North Star Imaging, St. Paul, Minn.) of the restorative filled syringe and tip confirmed that there were no air bubbles present in the tip.

The examples described above are intended solely to be illustrative, rather than predictive, and variations in the testing procedure can be expected to yield different results.

The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

What is claimed is:

1. A device for dispensing a composition, comprising:
a tip comprising an inner tapered funnel portion;
a hollow barrel including an outer tapered surface portion, an inner surface, an open front end, and an open back end opposite the front end; and
a piston,
wherein the outer tapered surface portion of the barrel aligns and releasably engages with the inner tapered funnel portion of the tip, and wherein the piston is in sliding engagement with the barrel.

2. The device of claim 1, wherein the inner tapered funnel portion of the tip includes a conical surface.

3. The device of claim 2, wherein the outer tapered surface portion of the barrel includes a conical surface.

4. The device of claim 3, wherein the conical surface of the outer tapered surface portion of the barrel aligns and releasably engages with the conical surface of the inner tapered funnel portion of the tip.

5. The device of claim 1 further including a dental composition within the device.

6. The device of claim 5, wherein the dental composition is dispensed when the piston is moved relative to the hollow barrel and the dental composition is not dispensed when the piston stops relative to the hollow barrel.

7. The device of claim 5, wherein the dental composition is dispensed from the device with essentially no air bubbles forming within the dental composition in the tip.

8. The device of claim 5, wherein there is no run-on of dental composition from the tip after the piston is stopped relative to the hollow barrel.

9. The device of claim 1, wherein the barrel includes a threaded portion, and wherein the outer tapered surface portion and threaded portion of the barrel are easily disinfected after use.

10. The device of claim 1, wherein the outer tapered surface portion of the barrel includes a plurality of venting grooves adjacent the open front end.

11. The device of claim 10, where the plurality of venting grooves are parallel and coincident with each other and form helix around the outer tapered surface portion of the barrel.

12. The device of claim 10, wherein the outer tapered surface comprises trapezoidal portions between adjacent venting grooves.

13. The device of claim 10, wherein the plurality of venting grooves are in a helical pattern on the outer tapered surface.

14. The device of claim 10, wherein the plurality of venting grooves have a trapezoidal cross-section.

15. The device of claim 14, wherein the plurality of venting grooves have a cross-sectional area ranging from 0.006 square millimeters to 0.06 square millimeters.

16. The device of claim 10, wherein the grooves extend across two or more grooved regions, the grooved regions being spaced apart from each other.

17. The device of claim 1, wherein the tip further comprises a dome portion adjacent the inner tapered funnel portion, and the device further comprises a cannula attached to the tip at the dome portion.

18. A method of dispensing a composition from a device, comprising:
providing a device for dispensing a composition, comprising:
a tip comprising an inner tapered funnel portion;
a hollow barrel including an outer tapered surface portion, an inner surface, an open front end, and an open back end opposite the front end; and
a piston,
wherein the outer tapered surface portion of the barrel aligns and releasably engages with the inner tapered funnel portion of the tip, and wherein the piston is in sliding engagement with the barrel;
filling the device with a dental composition; and
dispensing the dental composition by moving the piston relative to the hollow barrel, wherein the dental composition is dispensed when the piston is moved relative to the hollow barrel and the dental composition is not dispensed when the piston stops relative to the hollow barrel.

19. The method of claim 18, wherein the dispensing step includes dispensing the dental composition from the device with essentially no air bubbles forming within the dental composition in the tip.

20. The method of claim 18, wherein the dispensing step includes no run-on of dental composition from the tip after the piston is stopped relative to the hollow barrel.

21. The method of claim 18, wherein the inner tapered funnel portion of the tip includes a conical surface, wherein the outer tapered surface portion of the barrel includes a conical surface, and wherein the conical surface of the outer tapered surface portion of the barrel aligns and releasably engages with the conical surface of the inner tapered funnel portion of the tip.

22. The method of claim 18, wherein the outer tapered surface of the barrel includes a plurality of venting grooves adjacent the open front end.

23. The method of claim 18, wherein the hollow barrel includes a threaded portion, and wherein the outer tapered surface portion and threaded portion of the hollow barrel are easily disinfected after use.

24. A device for dispensing a composition, comprising:
a tip comprising an inner tapered funnel portion and a dome portion adjacent the inner tapered funnel portion, wherein the inner tapered funnel portion of the tip includes a conical surface;
a hollow barrel including an outer tapered surface portion including a conical surface and a plurality of venting grooves, an inner surface, an open front end, and an open back end opposite the front end;
a piston; and
a cannula attached to the tip at the dome portion;
wherein the conical surface of the outer tapered surface portion of the barrel aligns and releasably engages with the conical surface of the inner tapered funnel portion of the tip.
